(19) United States
(12) Patent Application Publication
(10) Pub. No.: US 2009/0139167 A1
(43) Pub. Date: Jun. 4, 2009

(54) CONNECTOR FOR PANELLING

(76) Inventors: Glen Murray Donaldson, Thames (NZ); Leonie Rose Donaldson, Thames (NZ)

Correspondence Address: GREER, BURNS & CRAIN, 300 S WACKER DR, 25TH FLOOR, CHICAGO, IL, 60606, US

(21) Appl. No.: 12/088,574

(22) PCT Filed: Feb. 8, 2006
(86) PCT No.: PCT/NZ06/00011

§ 371 Date: Jul. 18, 2008

(30) Foreign Application Priority Data
Sep. 29, 2005 (NZ) 542756

(51) Int. Cl. F16B 5/00; E04B 2/00

(52) U.S. Cl. 52/272; 403/23; 52/745.21

(57) ABSTRACT

A connector having at least one channel configured to receive the edge of a soft centred panel to be connected wherein the interior walls of the channel are smooth and the end portion of the soft centred panel abuts substantially all the internal area of the channel and at least one attachment portion configured to receive at lease one finishing accessory.

### TECHNICAL FIELD

This invention relates to a construction system for soft centred panels.

Specifically this invention relates to joining and connecter devices for use with soft centred panels, to join same in a variety of orientations to a variety of other soft centred panels or accessories.

### BACKGROUND ART

Traditionally mobile vehicles, trailers and buildings such as caravans, campervans and motor homes have had the interior outfitted with joinery to provide storage space and provide the most efficient utilisation of the space available. Most mobile vehicles have a large number of compartments, including but not limited to: cupboards, drawers, and standard furniture requirements such as bench tops and folding out tables.

These components must be strong enough to withstand travelling considerable distances at various speeds over a wide range of road conditions. It is therefore imperative that these be robust and strong enough to withstand the wear and tear that they receive.

Of almost equal value for many people however, is the aesthetics of the interior of the mobile vehicle, so that it is a pleasant space in which to spend time and looks neat, tidy and professionally finished.

Another large consideration when outfitting such a vehicle is the overall weight of the vehicle when finished. Mobile homes must fit within specific requirements in regard to size and weight, so that people do not require specialised licenses to drive same.

Lighter vehicles are less expensive to run in terms of fuel required. Lighter caravans are also easier to manoeuvre, and a smaller vehicle may be able to tow same.

It is therefore imperative that the interior of the mobile vehicle is outfitted with as lightweight material as possible to provide the required strength and aesthetics of the finished product, while keeping the weight as low as possible.

Lightweight components are not just limited to mobile homes such as campervans and caravans, they are also desired in low wear areas such as batches, children's play areas and to provide temporary storage.

In order to obtain the required strength, there have in the past been two major options of materials to use to produce lightweight components.

The first of these involves items being framed and then an outer and inner ‘skin’/cladding being applied to both sides to provide the desired finish. The frame and cladding can then be screwed or attached to other components by traditional joining methods such as nailing, screwing or gluing to provide sufficient strength.

The disadvantages with this method is that it is very time consuming to make each component, with a separate frame and cladding having to be applied to same. It is also necessary to build a complete new frame if you want to vary the size or shape of a specific component.

Another alternative is the use of medium density fibreboard (MDF) or chipboard panels. These can be cut to any size or shape, and also attached using traditional methods such as screwing or nailing together. MDF and chipboard panels weigh approximately 700 kg per cubic metre; therefore a significant weight is still associated with components built out of these materials.

Lighter weight materials are available such as soft centred panels wherein a layer of polystyrene or corrugated cardboard is boarded with a hard exterior layer on either side. However although these are very lightweight materials, in the past it has been difficult to join same to provide sufficient strength.

Problems associated with such soft centred panels include the following:
They are usually unsuitable for screwing into another component as the screw will only bite into the thin outer layer and not the soft centre material, leading to a weak connection and easy separation of the outer coating from the soft centre.
This is particularly noticeable in the case of end fixing, such as when the end of one panel abuts to a vertical surface of another (being the hard exterior surface), wherein the nail or screw is positioned through the vertical panel and into the end of the horizontal panel. This is the normal practice for joining wood or MDF/chipboard materials. When soft centred panels are used positioning a nail or screw into the soft centred material in the end of a panel will not provide sufficient strength.
Similarly as above, soft centred panels are also unsuitable for end fixing to form a corner.
Soft centred panels are also unsuitable for various fixtures and fittings, such as edge trim, brackets or other fittings as it will often lead to de-lamentation of the exterior cladding from the soft centred interior, or separation will occur from the attached fixtures or fittings. This is often also usually due to the problems relating to applying screws or nails to the soft centred panels.
It is often difficult to edge finish or attach a trim to the edge of soft centred panels.

Some attachment devices have been developed by Hafele, being connectors for honeycomb panels (utilising a honey comb structure made from recycled cardboard, corrugated cardboard for the middle layer, boarded with various different outer layers).

There are however a number of disadvantages associated with these attachment devices, including the following:
They only connect to the panels in one spot, therefore a large amount of pressure is placed on this spot, and do not provide continuous support along the entire length of the panel connection,
They are limited to right angle connections between two soft centred panels,
They cannot be used to connect soft centred panels with floors, ceilings or walls,
They are visible and therefore the aesthetics of the component is decreased,
They do not act to prevent de-lamination or separation of the outer cladding of the soft centred panels (even at the point of connection), de-lamination is therefore a common problem when these types of connectors are used, especially of the near edge of the soft centred panel.

A number of patents cover different attachment means to panels and varying configuration of panels, some of these are discussed briefly below. All these documents however have some disadvantage when used with soft centred panels, and when quick and easy finishing of a connection is desired.

GB 2,127,876 discloses a connecting corner structure of a curtain wall which provides heat insulation between same. The corner structure includes a curved portion which runs around the corner, acting as a pillar; the structure also has indoor and outdoor sections which form a groove between them in which a panel is positioned. GB 2,127,8 does not allow for the attachment of panels other than at 900 to each other, and does not allow for the attachment of accessories other than the two panels.

FR 2 797 476 discloses an attachment means for panels and other portions. The attachments can have a number of configurations and incorporate a number of units which can be attached to provide one to four attachment portions. The attachment means are channels with interlocking portions into which the panels are inserted. Having interlocking portions on the interior of the channels into which the panels are inserted increases the complexity of the moulding and cost to produce the attachment means. Again FR 2 797 476 does not allow for the attachment of accessories other than panels.

EP 1 316 496 discloses a method for fastening convergent floors of prefabricated, self supporting structures, including the steps of: prearranging boards having along an edge at least a profiled groove; arranging at least two boards at a predetermined angle, with said grooves parallel and approached to each other; connecting said boards to each other, by introducing in said profiled grooves at least a junction element that engages with both; locking said or each junction element causing said boards to be integral and self supported.

The grooves are provided by means of application of profiled sections having a side a longitudinal channel suitable for receiving the edges of the boards, integrated to them by gluing, and at the other side the groove same.”

All the examples given in the specification require two separate portions (profiled sections) to be attached to the edges of the soft centred boards; these contain a groove on the exterior side to which the junction element is attached. Having extra pieces which need to be used once again increases the complexity of the moulding and cost to produce the attachment means. Again EP 1 316 496 does not allow for the attachment of accessories other than panels.

EP 327 465 discloses an attachment means incorporating channels with protruding portions or fins into which the panels are inserted. It also appears that the connectors disclosed in this citation have a central portion from which ‘channels’ extend from in four directions. FIG. 1 of EP 327 465 shows the channels have clips inserted which then interact and connect to a further clip on the panel to be connected. The use of clips to attach panels into the channels increases the complexity of the moulding and cost to produce the attachment means. Again EP 327 465 does not allow for the attachment of accessories other than panels.

DE 3446734 discloses a box construction, especially for on the back of utility vehicle. The box construction incorporates an external frame work in the form of assembled section strips which are connected via connection pieces. The section strip is connected through the connector unit via dovetail guides and has a plate which can be secured to the framework of the vehicle or the box construction.

The use of dovetail guides on the interior of the channels to attach panels into the channels increases the complexity of the moulding and cost to produce the attachment means.

U.S. Pat. No. 5,984,044 disclose the formation of an acoustical barrier wall for use next to road ways or other noise producers. The wall consists of a base to which are attached vertically extending H-beams, each side of which is adapted to receive the edge of a panel.

U.S. Pat. No. 4,020,611 discloses a wall assembly for laminated panels, where each panel is provided with a thermal break or barrier elements and an improved joint arrangement for same. The opposed edges of adjacent panels are preferably provided with rails made from light metal extrusions. Each panel edge is comprised of a pair of such rails into which strips of insulting material are inserted and anchored in an improved fashion such that the extruded elements simulate I-beam flanges connected by a web of plastic insulating material or the like. The connection disclosed in U.S. Pat. No. 4,020,611 requires a pair of joining elements each attached to one side of the panel or the other.

The connectors disclosed in U.S. Pat. No. 4,020,611 act by connecting individually the two sides of a soft centred panel, this requires that a portion of the soft centre is removed to enable attachment to the two rigid panels either side. This therefore increases the labour and therefore cost required to apply the connectors. Cutting out interior portions of the soft centre may also be time consuming and difficult where the panels are provided in a kitset where there are different ways of joining same.

U.S. Pat. No. 3,866,381 discloses an extrusion for receiving and interconnecting laminated panel sections for quick construction of partitions or enclosures. The extrusions include channel portions adapted to receive the edges of the panels, the panels being grooved and adapted to snap into the corresponding channels.

The extrusions may be H shaped in cross section for forming panels into a flat partition or wall, may be formed with a channel on one side and adapted to receive a door or window fittings on the other side, or may be formed into a corner unit configuration to permit joining of panels at right angles. The corner unit extrusion includes two interlocking half members which define a central cavity for receiving a rigid pipe, which prevents the interlocking members from being separated.

The connectors disclosed in the above documents do not provide connectors which can be used in a number of configurations to produce a light weight building system and allow same to be easily and quickly finished with a number of finishes or finishing accessories.

Therefore it would be beneficial to those constructing accessories for mobile vehicles, or any other accommodation, or furniture, or lightweight components if there was available a method of using soft centred panels quickly and easily such that a lightweight yet strong building component could be produced.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a connector for soft centred panels and accessories, the connector including:
at least one channel configured to receive the edge of a soft centred panel to be connected wherein the interior walls of the channel are smooth and the end portion of the soft centred panel abuts substantially all the internal area of the channel, and
at least one attachment portion configured to receive at least one finishing accessory.

According to another aspect of the present invention there is provided a method of construction using soft centred panels, using a connector, the connector including
a least one channel configured to receive the edge of a soft centred panel to be connected wherein the interior walls of the channel are smooth and the end portion of the soft centred panel abuts substantially all the internal area of the channel, and
at least one attachment portion configured to receive at lease one finishing accessory,
   the method characterised by the steps of
(a) fitting the edge of at least one soft centred panel into the channel
(b) fitting a finishing accessory into the attachment portion.

The construction system according to the present invention includes a number of connectors configured to attach soft centred panels in a variety of orientations, and to a number of finishing accessories.

Throughout this specification the term finishing accessory should be taken as meaning any accessory which provides a neat and tidy cover to the connector. Finishing connectors may include trim, corner covers, base trim or the like.

One significant advantage of using finishing accessories is that they are easily removed to provide access to the connector if required at a later date. Alternatively a different style or colour of trim may be applied to provide updated colour schemes or patterns.

Having the interior walls of the channels smooth increases the ease with which the edge of a soft centred panel can be fitted into same, it also decreases the complexity of manufacture and therefore decreases the material and cost of manufacturing same.

Throughout this specification the term smooth should be taken as meaning having no substantial protrusions into the channel. The surface of the channel may be roughened, but not have any significant protrusions from same.

Having substantially the entire end portion of the soft centred panel abutting the interior area of the channel increases the surface area providing the attachment. This increases the strength of the connection. It also decreases the preparation required to the edge of the soft centred panel before it can be fitted to the channel. The panel can simply be cut and the edge of same fitted into the channel of the connector.

In a preferred embodiment the connector may be moulded out of a plastic material, and shall be referred to as such herein. However this should not be seen as limiting as the other suitable material such as metal maybe utilised.

In one embodiment Polyving Chloride (PVC) semi rigid and rigid plastic may be used. In an alternative embodiment acrilonitrile-butadiene-styrene (ABS) may be utilised. ABS is known to be susceptible to UV breakdown, therefore a UV blocker may also be incorporated if ABS were the plastic of choice.

In a preferred embodiment the connector may be moulded from a die, however this should not be seen as limiting as other methods such as extrusion may be used to manufacture same.

In one preferred embodiment the connectors may be made of a material which is sufficiently elastic to enable the edge of a soft centred panel or other finishing accessory to be pushed onto same, however strong enough to ensure that once the soft centred panel or other finishing accessory is in position it is well secured, and will not easily become detached.

Throughout this specification the term elastic, elasticity or deformability should be taken to mean flexible and able to move from its original position, but which has some bias towards it original shape.

In some embodiments the channel(s) may taper in towards the open end in order to allow the edge of a soft centred panel to pass through but also to provide extra strength to the join.

The combination of the deformability of the material of the connector, and the taper on the channel provide sufficient frictional force to hold the soft centred panel in position within the channel.

In a preferred embodiment the soft centred panel(s) and/or finishing accessories may be fitted to the connectors by hand, however this should not be seen as limiting as any other method which produces enough force to attach same may be used.

In a preferred embodiment the channel may also have glue or other adhesive applied before the edge of a soft centred panel is fitted into same. This increases the strength of the connection and provides a permanent fix between same.

In one embodiment the adhesive may be applied to the two internal corners of the channel, this allows the adhesive to squeeze around the side edges of the panel and improves the grip, it also prevents the adhesive getting scraped of as it is pushed into the chanel.

In an alternative embodiment the adhesive may be applied to the edge, or end portion, or both of the soft centred panel before same is fitted into the channel.

In a preferred embodiment the attachment portion configured to receive a finishing accessory may have a securing lip. However this should not be seen as limiting as the attachment portion may be smooth and with or without a taper. Adhesive may also be utilized.

For example when trim is used as a finishing accessory to finish a join or corner and add to the aesthetics of the component, the trim may have a portion configured to be secured by the securing lip. As different finishing accessories may be used and therefore the taper or securing lip may be specific to same.

Throughout this specification the attachment portion configured to receive a finishing accessory shall be referred to as having a securing lip, or protrusions which interact with corresponding portion of the finishing accessory.

In preferred embodiments the securing lip extends substantially along the full length of the connector, thereby providing a strong and secure connection between the connector and the finishing accessory, however this should not be seen as limiting, as a securing lip along only part of or at specific intervals along the connector may be utilized.

In a preferred embodiment the soft centre panel may be a panel whereby the centre section is made of a soft material, which is boarded each side by a hard cladding.

Throughout this specification the term soft centre may be taken to refer to a polystyrene centred panel, however this should not be seen as limiting as other soft centres such as corrugated cardboard or any other suitable material may be utilised using the present invention.

In a preferred embodiment the overall thickness of the soft centred panel may vary depending on the overall required strength of the panel. For most internal accessories and cabinetry is the thickness of the soft centred panel is preferably within the range of 12 to 50 mm. In particularly preferred embodiments the thickness of the soft centred panel may be 19.5 mm. However this should not be seen as limiting as other thicknesses may be utilized depending on the requirements of the panel.

In a preferred embodiment the thickness of the outer cladding of the soft centred panel may vary depending on the required strength and overall thickness of the panel. Preferably, for internal uses and cabinetry the thickness may be within the range of 2.7 to 4 mm. In particularly preferred embodiments the thickness of the cladding on the soft centred panel may be 2.7 mm. However this should not be seen as limiting as other thicknesses may be utilized depending on the requirements of the panel.

In a preferred embodiment the thickness of the soft centre of the soft centred panel may vary depending on the overall thickness of the panel. Preferably however the for internal uses and cabinetry the thickness may be within the range of 6.6 to 44.6 mm. In particularly preferred embodiments the thickness of the cladding on the soft centred panel may be 14 mm. However this should not be seen as limiting as other thicknesses may be utilized depending on the requirements of the panel.

In preferred embodiments the hard exterior coating of the soft centred panel may be varied depending on the finish desired. For example the coating may be coloured, or have a variety of wood finishes.

In a preferred embodiment the outer cladding for the soft centred panels may vary depending on the required strength or aesthetics of the panel. Some examples of material which may be used for the outer cladding of the soft centred panels are 2.7 mm plywood with a range of possible veneers such as natural timber veneers, vynals in wood grains, plain colours and patterns, fabrics. Another alternative may be 3 mm custom wood with natural timber veneers, vynals in wood grains, plain colours and patterns, low and high pressure melamine or high pressure Laminate of any finish. Further alternatives include plastic sheeting, metals, or thin solid timber veneers.

In preferred embodiments the finishing accessories may have an exterior coating which is consistent with or coordinated with the exterior coating of the soft centred panel(s). This provides an aesthetically pleasing finish to the connection, or construction utilizing same. However, this should not be seen as limiting as a contrasting finish may be desired.

The soft centred panels utilized by the current invention are very easy to manipulate and cut to differing sizes and shapes, or to alter same if a different aesthetic view is wanted or the panel does not fit correctly.

Soft centred panels are also easy to move around (both before and after construction).

Both these factors provide significant advantages over previous methods such as having to frame panels to provide solid framed edges to allow nails or screws to be used to connect adjacent panels, or use of heavier material such as MDF or chipboard.

In a preferred embodiment the connector has at least one channel which is configured to receive the edge of the soft centred panel. Preferably this is configured to the width of the soft centred panel such that a snug fit is provided between same. The width of the channel may be varied to accommodate different width panels, for example, when the connectors are provided with pre-cut panels as a kitset. Alternatively, the channels may be configured to receive the edge of soft centred panels which are commercially available.

In preferred embodiments soft centred panels, connected according to the present invention may be utilized to construct interior compartments and components for the interior of mobile homes such as campervans and caravans. However this should not be seen as limiting as they may also be used in low wear areas such as batches, children's play areas, to provide temporary storage or any other situation where lightweight components are required. It may be that parts of the exterior or structural portions of the mobile homes may also incorporate components constructed according to the present invention.

The above indicates the use of connectors according to the present invention for attachment of soft centred panel(s) to a finishing accessory. However this should not be seen as limiting as soft centred panels may be attached according to the present invention to existing features or fixtures present and other types of material, such as solid wood, MDF or chip board components.

In a preferred embodiment the connectors may run the whole distance of the portion of the soft centred panel, second soft centred panel, finishing accessory or other feature to which the first soft centred panel is being attached. This provides long run channels which hold the soft centred panel(s) and/or finishing accessories. This ensures that sufficient support and strength is given to the soft centred panel along its length.

However this should not be seen as limiting as the connectors may be positioned along only some or at intervals along the adjacent portions.

Having the connector running along the entire length of the adjacent portions of soft centred panels and/or finishing accessories, to be joined (therefore having long run channels) provides greater structural strength and support to same, therefore providing a stronger join than would be possible if the connector did not run the entire length.

A list of the major connectors and finishing accessories, along with cross-sectional views and descriptions of use are given in Table 1.

In some embodiments the edges of the connectors, most specifically the edges of the channel(s) may have a number of divisions or segregations so that connectors have sufficient flexibility to be able to be attached around curved corners or portions of soft centred panels. However this should not be seen as limiting as the connectors are integral and continuous in most preferred embodiments.

Throughout this specification the term segregations should be taken as meaning having regular or irregular splits into the side(s) of the channel in order to allow same to be fitted around the curved edge of a soft centred panel.

In a preferred embodiment the required panels, connectors and finishing accessories for constructing a specific component, compartment or piece of carpentry may be provided as a kitset, including for example to construct a cupboard, the kitset may include: side panels, top and bottom panels, a front door, hinges, corner connectors and trim for same and edge trim. However this should not be seen as limiting as the panels and connectors in the kitset may be provided in any other form.

The present invention has significant advantages over previous methods of constructing light weight components and structures. It allows the use of soft centred panels which are extremely lightweight, provides structural strength to the panels through use of long run channels and provides a system for connecting same to other soft centred panels, other components or finishing accessories which is robust and easy to achieve. It provides a number of connectors for same which are easy to use, and which can be used to connect soft centred panels in a large variety of orientations. Finishing accessories for use with the present invention also include trims to provide a neat finish and other fixings such as hinges and handles which are adapted to provide a strong attachment to soft centred panels.

The present invention overcomes the major problems with using soft centred panels, as discussed in the background art section, such as an inability to obtain sufficient strength from end joining, via providing connectors and finishing accessories which provide the required strength and support to join soft centred panels in a large number of orientations, and join a large number of fixtures such as hinges or rails to same.

The use of polystyrene centred panels also provides the advantage that conduits are easily put through the soft centred portion of same to provide services such as power to particular areas of the component/joinery. When MDF or other materials are used it is difficult to drill holes through the centre of same when any curve is required. For example a heated rod can be used to easily produce a conduit through polystyrene, with the side panels being drilled where the conduit is to enter or exit the panel.

The soft centred panels utilized by the current invention are very easy to manipulate and cut to differing sizes and shapes, or to alter same if a different aesthetic view is wanted or the panel does not fit correctly. Soft centred panels are also easy to move around (both before and after construction), this provides significant advantages over previous methods such as having to frame panels or use of heavier material such as MDF or chipboard.

One significant advantage of using finishing accessories is that they are easily removed to provide access to the connector if required at a later date, alternatively a different style or colour of trim may be applied to provide updated colour schemes or patterns.

Having the interior walls of the channels smooth increases the ease with which the edge of a soft centred panel can be fitted into same, it also decreases the complexity of manufacture and therefore decreases the material and cost of manufacturing same.

### BRIEF DESCRIPTION OF DRAWINGS

Further aspects of the present invention will become apparent from the following description which is given by way of example only and with reference to the accompanying drawings in which:

FIG. 1 a) shows a schematic of a cross-section of a corner connector according to one aspect of the present invention,

b) shows same in use, connecting soft centred panels and trim, and

FIG. 2 shows a schematic of a cross-section of a corner trim configured to fit to the corner connector as shown in the FIG. 1, and

FIG. 3 a) shows a schematic of a cross-section of a base connector according to a further aspect of the present invention,

b) shows same in use, including soft centred panel, and

FIG. 4 a) shows a schematic of a cross-section of a trim configured to fit in the base connector as shown in FIG. 3,

b) shows same in use, and

FIG. 5 shows a schematic of a cross-section of a ceiling base connector according to a further aspect of the present invention, and

FIG. 6 a) shows a schematic of a cross-section of an connector incorporating an ‘F channel’ according to a further aspect of the present invention,

b) shows same in use, and

FIG. 7 a) shows a schematic of a cross-section of an finishing accessory, being self adhesive trim for use on exposed edges of soft centred panels,

b) shows same in use, and

FIG. 8 shows a schematic of a cross-section which shows a further finishing accessory of the present invention, being a cap, and

FIG. 9 a) shows a schematic of a cross-section of a further connector of the presenting invention, being a joiner to join to adjacent soft centred panels orientated in the same directions,

b) shows same in use, and

FIG. 10 shows a schematic of a cross-section of a rail and corner, and

FIG. 11 shows a schematic of a cross-section of a hinge, and

FIGS. 12 a), b), c) and d) show a schematic of a hinge plate from top a), side b), end c) and perspective d) angles.

### BEST MODES FOR CARRYING OUT THE INVENTION

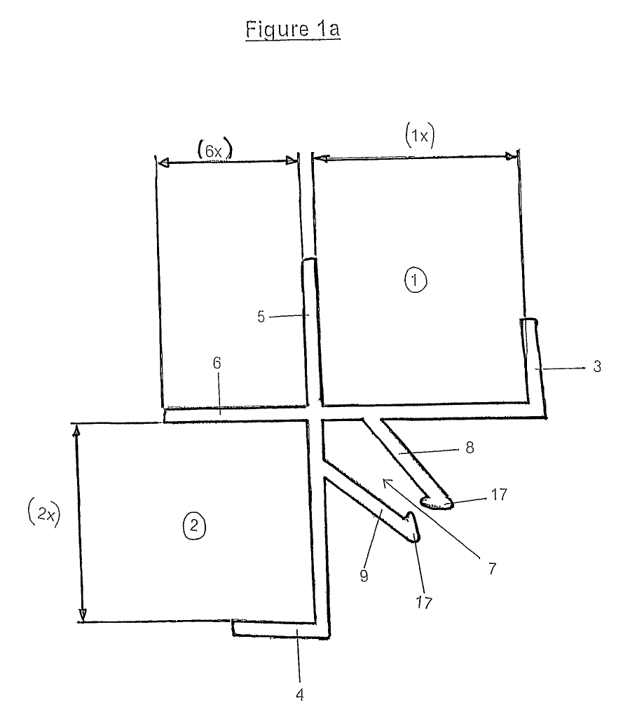

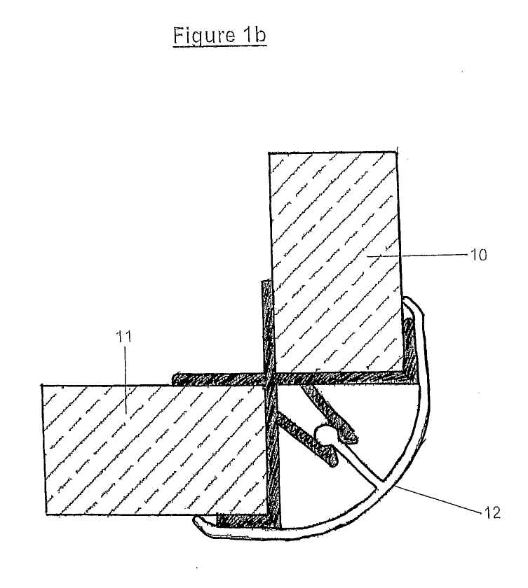

FIG. 1a shows a schematic of a corner connector which is utilised to connect two soft centred panels, orientated at 90° to one another. The connector incorporates a first channel (1), which is configured to fit the edge of one soft sample panel, and a second channel (2) configured to fit the edge of a second soft centred to panel to be orientated at 90° to the panel which is fitted into channel (1).

Each of the channels has an outer edge (3, 4 respectively), and an inside edge (5, 6 respectively). The outer edge (3, 4) is shorter than the inner edge so that it is easier to cover same with trim to finish off the exterior of the corners. The inner edges (5, 6) may be longer to provide extra strength and stability to the connection.

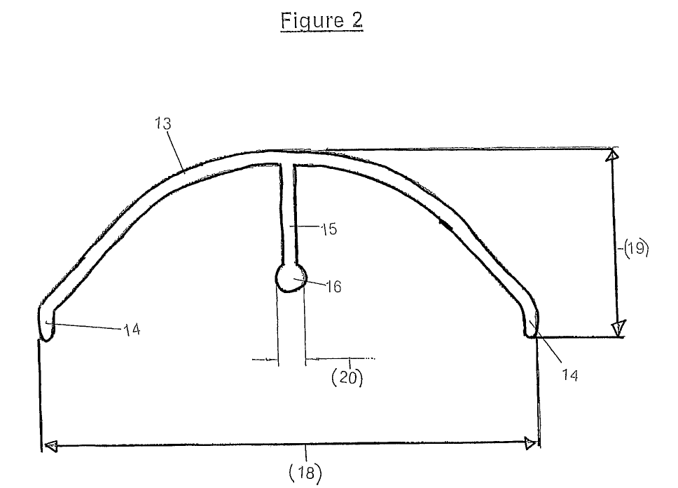

The connector also includes a third channel (generally shown by (7)), which includes two side panels (8, 9), configured to fit a trim panel as shown in FIG. 2.

The preferred interior width of the channels (1, 2) is 19 mm at the base of the channel (1x) and 19 mm at the opening of the channel (2x), thereby providing some inward taper from the base to the opening of the channel to increase the hold on the edge of the soft centred panels fixed in the respective channels.

Preferable the edge of the panels are also glued to the base/interior of the channels (1, 2 respectively). The interior edge (5, 6) extends 12 mm along the interior edge of the soft centred panel (6x). The wall thickness of the corner connector is 1.4 mm.

FIG. 1a shows a cross-sectional view of the connector on its own. FIG. 1b shows a cross-sectional view of same in use wherein two soft centred panels (10, 11) are fitted into channels (1 and 2 respectively). Corner trim (12) (as further shown in FIG. 2) has also been attached to channel (7).

FIG. 2 shows a schematic of an exterior corner trim (corner cap) configured to attach to the connector as shown in FIG. 1.

The trim incorporates a curved exterior portion (13), end portions (14) which when the trim is in place angle in towards the edge of the soft centred panel, thus providing a continuous trim finish without any gaps through which the connector is visible. It also incorporates a central portion (15) which fits into channel (7) of the connector as shown in FIG. 1 with a rounded end portion (16) which is configured to provide attachement to the connector as shown in FIG. 1 via the hook ends of channel (7) (shown by 17 in FIG. 1).

FIG. 1b shows a schematic of the trim as shown in FIG. 2 when connected to the connector as shown in FIG. 1a.

In preferred embodiments the dimensions of the trim as shown in FIG. 2 are as follows: from tip to tip the length (18) is 47.5 mm the height (19) is 18.2 mm, the middle portion (15) along with the rest of the trim exterior has a wall thickness of 1.4 mm. This increases to a circumference of 2.7 mm for the connecting portion (16) (as shown by 20).

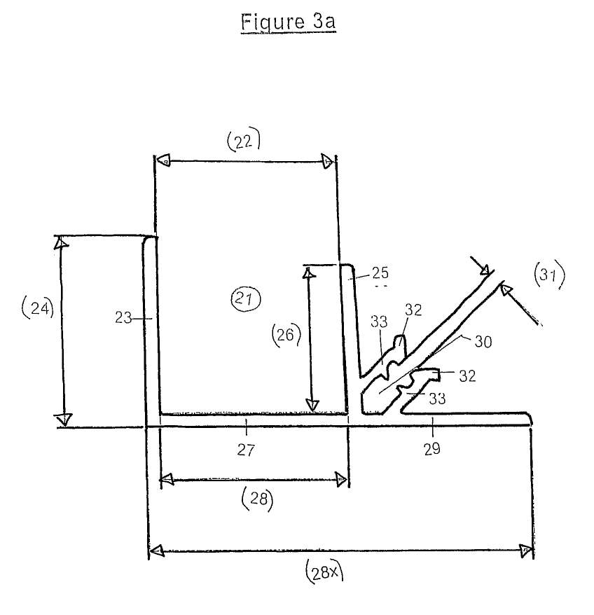

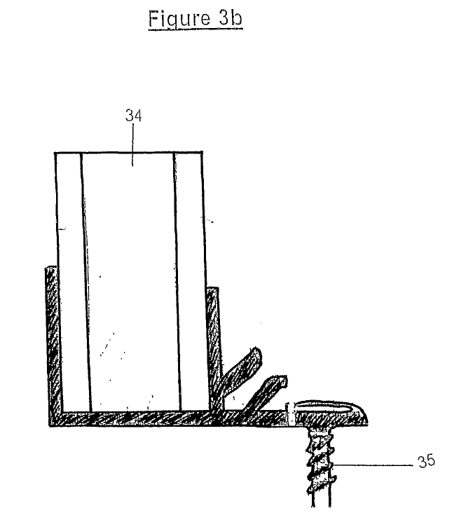

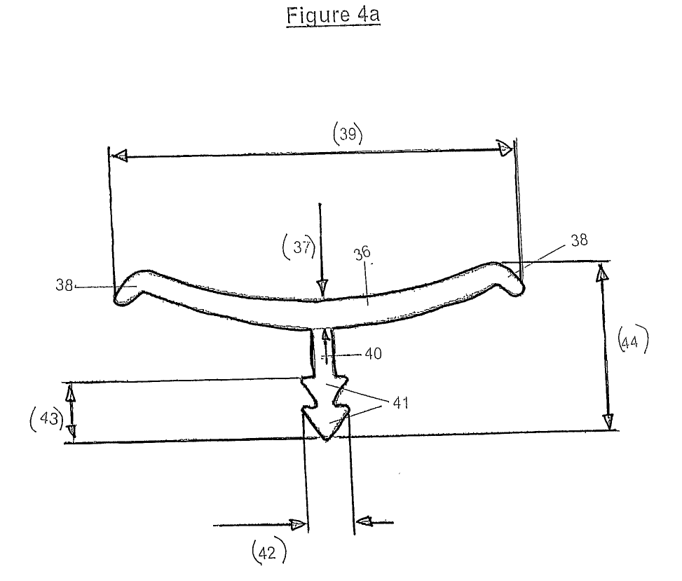

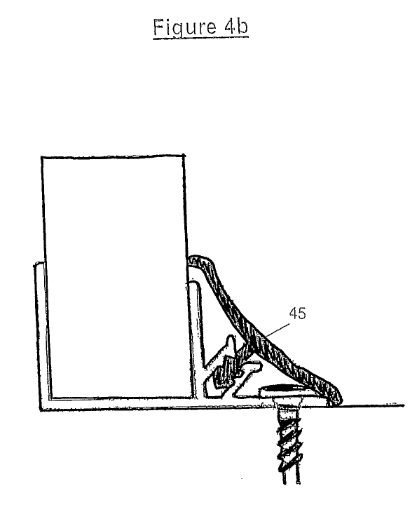

FIG. 3 shows a schematic of a base connector according to another aspect of the present invention. FIG. 3 shows a base moulding which is used adjacent to the floor and holds the base of the soft centred panel. This connector has trim which is attached via a second channel to cover same—(see FIG. 4).

FIG. 3a includes a channel (21), the channel (21) has an outer edge (23) with a height of 20 mm (24) and an inner edge (25) with a height of 15.5 mm (26). The channel (21) tapers in slightly from the base of same, with the base (27) having a width of 19.5 mm (28), whereas the top (22) has a width of 19 mm (both internal widths). The moulding has a total base length ((27) plus (29) plus wall thickness) of 40 mm (28x). This base may be fixed to the floor via a glue or other kind of adhesive.

The connector as shown in FIG. 3 also has a channel (30) to which the trim configured to fit in same (a schematic of this is shown in FIG. 4) is attached. The channel (30) has an exterior opening width of 1.5 mm (31). The channel (30) also has two hooks (32) and (33) on either side, which are configured to attach the trim securely to same. The wall thickness of the connector is 1.4 mm.

FIG. 3b shows the attachment as shown in FIG. 3a but also showing the positioning of a soft centred panel (34) in same. FIG. 3b also shows the additional option of including a screw (35) to help fix the moulding to the floor in addition to using adhesives.

FIG. 4a shows a schematic of the trim configured to fit into the connector as shown in FIG. 3a which acts to conceal fixings and protect the base of panels. This trim is configured to produce a curved line between the panel and the floor or other base/fixture. Unlike the other connections and trims the average wall thickness is 1.8 mm due to higher wear and tear that trim connected between the panel and the flooring is subjected to. The trim has an inwardly curved portion (36) which in its centre is 2 mm inwards from the exterior edges (37). At the end of the inwardly curved portions are ends (38). These ends (38) act to cover the ends of the connecting device as shown in FIG. 3 and produce a continuous surface from the side of the soft centred panel to the floor. The total width of the trim (39) is 29 mm.

In the centre of the trim is an extending portion (40) which has two triangular like portions ending in a point (41). These triangular portions (41) are configured so that once the trim is pushed into the channel ((30) in FIG. 3) the triangular portions (41) engage with the hook portions of the channel (30), (being (32) and (33) respectively as shown in FIG. 3). The triangular portions (41) have a total width of 3 mm (42) and a height of 4 mm (43). The total height of the trim is 12 mm (44).

FIG. 4b shows a schematic of the trim (45) attached to the connector and soft centred panel as shown in FIG. 3b.

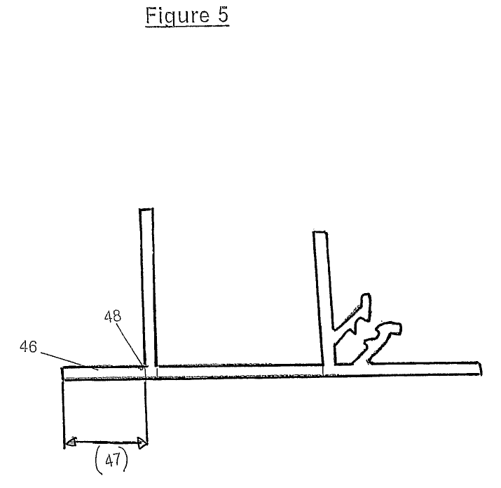

FIG. 5 shows a schematic of a ceiling base connector. This is very similar to that as shown in FIG. 3a incorporating a channel for fixing the base of a soft centred panel (front and back) and a channel to hold the trim (as shown in FIG. 4). The additional features of FIG. 5 (over FIG. 3a) is the further extension of the base panel (46) for a further 10 mm (47). There is also an added V notch (48). The purpose of the V notch is to allow the user to easily cut off the extension of the base panel (46) to convert the connector to a base connector (as shown in FIG. 3a), by providing a guide for a knife.

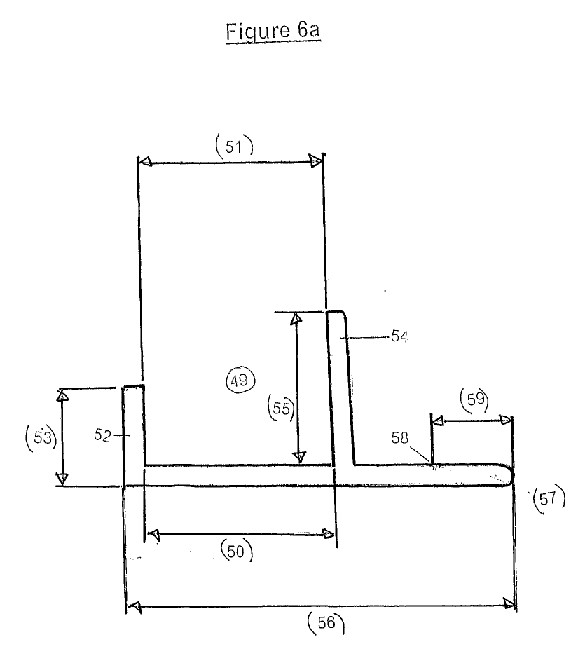

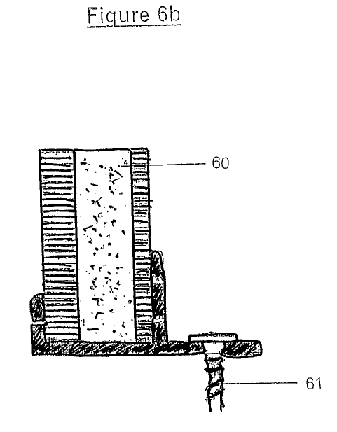

FIG. 6a shows a schematic of an ‘F channel’ for sealing internal edges to soft centred panels where external, ‘finishing’ trim is not required.

FIG. 6a shows a schematic of a cross section of the connector which incorporates a channel (49) with an internal width at the base (50) of 19.8 mm and a top width (51) of 19 mm. This connector has a wall thickness of 2 mm. The channel has an outer edge (52) which is 10 mm high (53) and an inner edge (54) which has a height from the interior of the base of 15.5 mm (55). The base is a total width of 40 mm (56) and includes a horizontal extension (57). The extension (57) has a V notch (58) positioned 8 mm in from the end (59).

FIG. 6b shows a schematic of the ‘F channel’ in use with a soft centred panel (60) being fitted into the channel (49). A screw (61) is positioned through the V notch (58) to help attach the cap base to the base structure in addition to any adhesives.

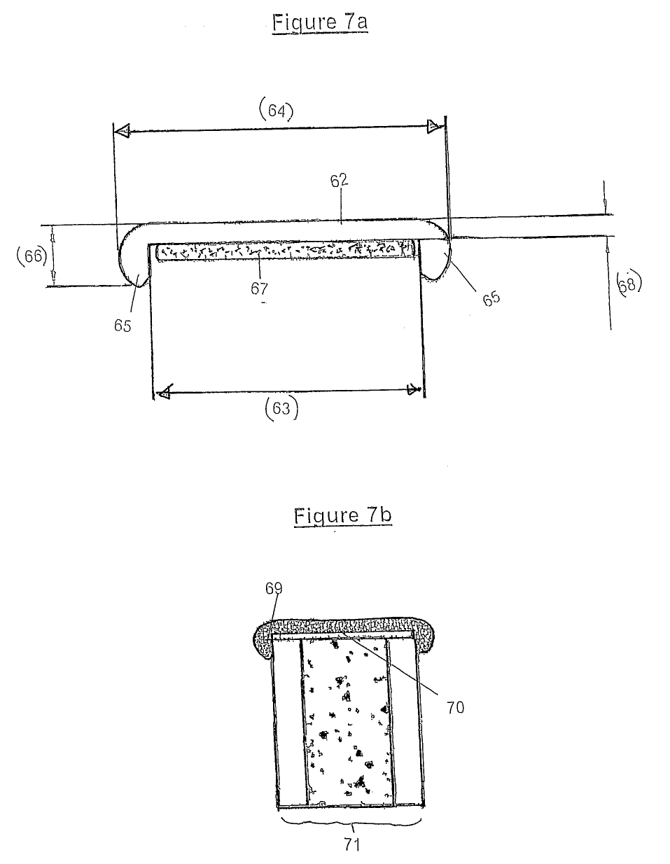

FIG. 7a shows a schematic of a flexible self adhesive trim for exposed edges of soft centred panels. The trim incorporates a covering portion (62) which has an interior width being the same as the width of the soft centred panel, being either 19.5 or 19.8 mm (63). The total width of the trim is 24.5 mm (64). The end portions (65) curve around the edge of the panel and extend downwards 4.5 mm from the top of the trim (66). The trim has a self adhesive tape or surface (67) which is used to attach the trim to the edge of the panel. The thickness of the top of the trim (68) is 1.5 mm.

FIG. 7b shows the trim generally shown by (69) and the adhesive (70) attached to a soft centred panel (71).

The self adhesive trim is flexible so that it is very easy to trim both straight edges and curved, such as round the curved corners of a bench top.

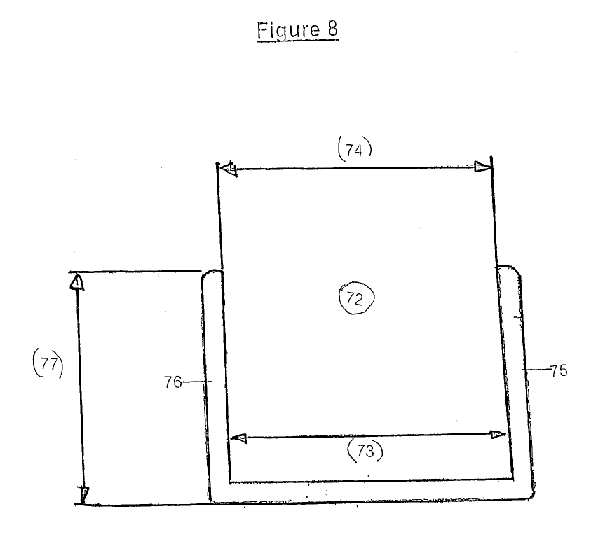

FIG. 8 shows a schematic of a ‘U channel’ finishing accessory which can also be used to cover edges of soft centred panels. The cap has a channel (72) which is configured to receive the edge of a soft centred panel. The base interior width of same is 19.5 mm (73) whereas the top is 19 mm (74). The edges (75) and (76) of the channel (72) are 16 mm high (77). The general wall thickness of the cap is 1.4 mm.

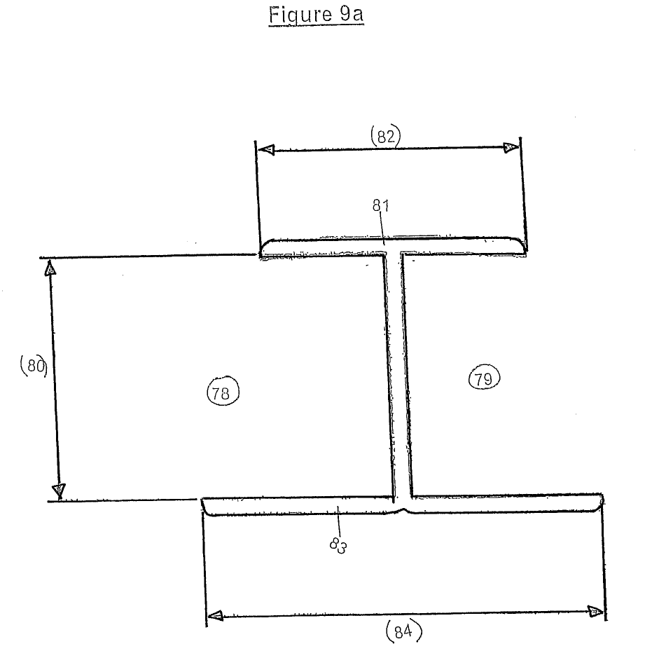

FIG. 9a shows a schematic of a joining connector which is used to join two adjacent edges of soft centred panels which are orientated in the same direction, i.e. both being horizontal or both being vertical. The connector incorporates two channels (78) and (79). The channels have an interior width of 20.3 mm (80). The top portion (81) of the connector is 22 mm in width (82) whereas the lower portion (83) has a total width of 33 mm (84).

FIG. 9b shows the connector generally shown by (85) with a soft centred panel attached to both channels (86) and (87) respectively.

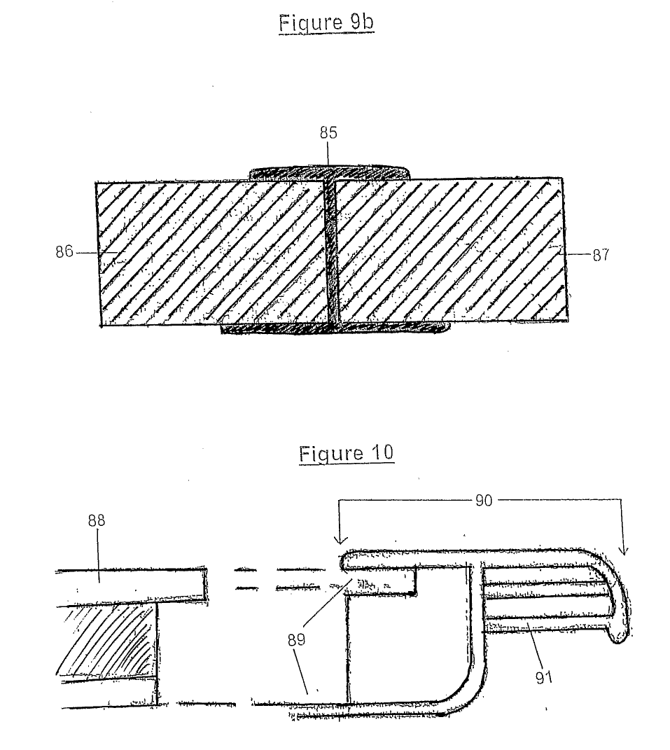

FIG. 10 shows a schematic of a rail, and one way of attaching same to a soft centred panel. A soft centred panel is cut so that it is as shown in (88) with one side cladding and the soft centre being cut off approximately 11 mm back from the edge of the remaining cladding side.

The rail has a channel adapted to fit same (89). The rail has a total width of 40 mm (90) and a rail portion (91). This rail portion (91) may be configured in a variety of manners depending on the required aesthetics and the purpose of the rail.

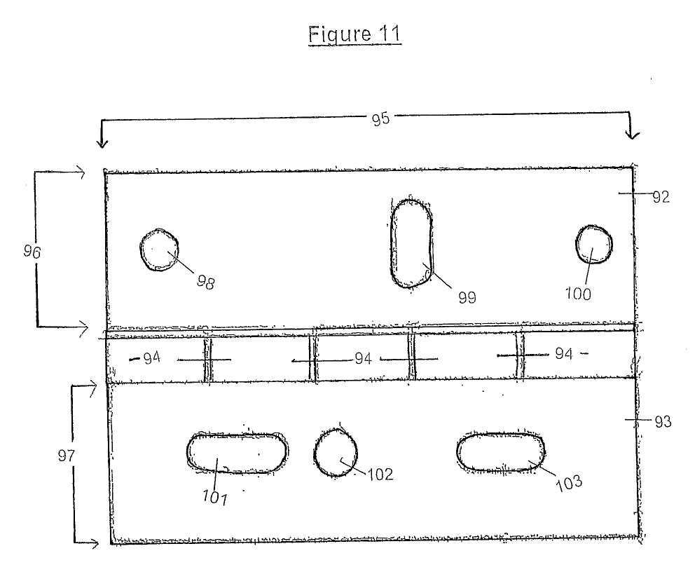

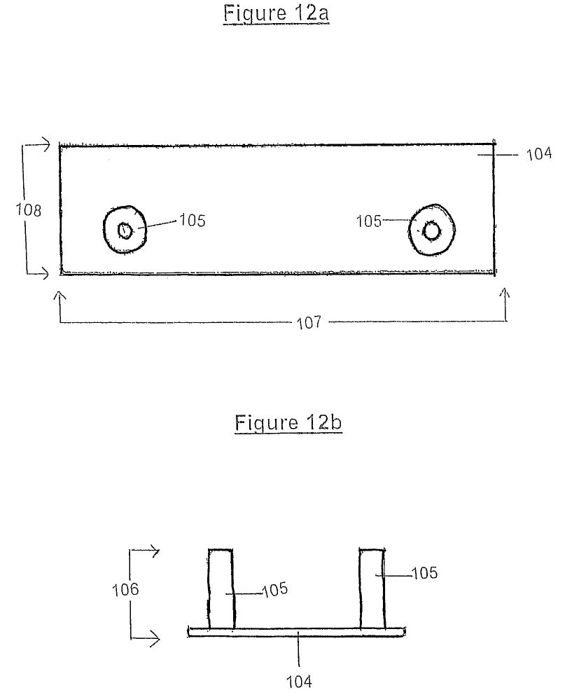

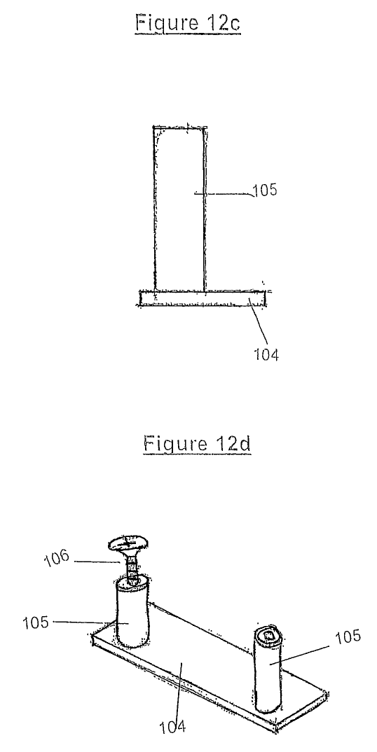

FIG. 11 shows a schematic of a hinge adapted to be attached to soft centred panels incorporating the hinge plate (as shown in FIG. 12). FIG. 11 shows the two hinge panels (92) and (93) respectively attached by the hinging portions (94). The hinge has a total width of 64 mm (95). Each hinge plate (92) and (93) has a height of 19 mm and 16 mm respectively (96) and (97). Each hinge has holes countersunk for 6 gram×16 mm screws (98-103 respectively).

FIG. 12 shows a schematic of a hinge plate which allows hinges to be attached to the edges of soft centred panels without providing undue stress or being easily pulled out of same due to lack of attachment through the soft centred portion of the panel. FIG. 12 shows a top (a) front (b) and side (c) as well as a perspective (d) view of the hinge plate. The hinge plate consists of a plate (104) and two protrusions (105). The protrusions have an exterior diameter of 6 mm and extend from the plate a distance of 19.5 mm (106). This distance allows the protrusions to fit through the cross section of a soft centred panel. The hinge (not shown in this Figure) is then screwed into the hinge plate via screws from the side opposing the plate (104) via screws (106) (FIG. 12b).

The plate spreads the area over which the hinge is attached to the soft centred panel and therefore spreads any forces due to same, thereby preventing the hinges and screws attaching the hinge to the soft centred panel being easily pulled out of the soft centred panel. The base of the hinged plate has dimensions of 48 mm (107) by 16 mm (108) as shown in FIG. 12a.

Aspects of the present invention have been described by way of example only and it should be appreciated that modifications and additions may be made thereto without departing from the scope thereof.

1. A connector, comprising:
at least one channel configured to receive the edge of a soft centred panel to be connected wherein the interior walls of the channel are smooth and the end portion of the soft centred panel abuts substantially all the internal area of the channel; and
at least one attachment portion configured to receive at lease one finishing accessory.

2. The connector as claimed in claim 1, wherein the connector is made of a plastics material.

3. The connector as claimed in claim 1, wherein the connector is made of a material which can be deformed.

4. The connector as claimed in claim 1, wherein the channel tapers in towards the open end.

5. The connector as claimed in claim 1, wherein the internal walls of the channel includes adhesive.

6. The connector as claimed in claim 1, wherein the connector extends substantially along the entire edge of the panel or finishing accessory to be connected.

7. The connector as claimed in claim 1, wherein edges of the connector are segmented to allow the connector to be formed to a curved configuration.

8. The connector as claimed in claim 1, wherein the attachment portion has a securing lip configured to interact with the finishing accessory.

9. A kitset, including
at least one connector as claimed in claim 1,
at least one soft centred panel to be connected; and
at least one finishing accessory.

10. A method of construction with soft centred panels, using a connector, the connector including a least one channel configured to receive the edge of a soft centred panel to be connected wherein the interior walls of the channel are smooth and the end portion of the soft centred panel abuts substantially all the internal area of the channel, and at least one attachment portion configured to receive at lease one finishing accessory, the method comprising:
a) fitting the edge of at least one soft centred panel into the channel, and
b) fitting a finishing accessory into the attachment portion.

11. (canceled)

12. (canceled)
